(19) United States
(12) Patent Application Publication
(10) Pub. No.: US 2007/0101039 A1
(43) Pub. Date: May 3, 2007

(54) Versatile docking station for portable electronic devices

(75) Inventors: Mark E. Rutledge, Murietta, CA (US); John Durbin, San Diego, CA (US)

Correspondence Address: Directed Electronics, One Viper way, Vista, CA, 92081, US

(73) Assignee: DEI HEADQUARTERS, INC.

(21) Appl. No.: 11/265,331

(22) Filed: Nov. 2, 2005

(51) Int. Cl. G06F 13/00

(52) U.S. Cl. 710/303

(57) ABSTRACT

A docking station provides supporting functions for multiple portable devices, such as music players, satellite radio receivers, games, and video players. The supporting functions may include providing power, audio amplifier, speakers, and video screen. To couple to a variety of portable devices, the docking station uses various adaptive cradles. In a typical configuration, a portable device is plugged into a cradle, which in turn is plugged into the docking station. The docking station recognizes the type of portable device plugged into the station, and adjust the power supply voltage to power the device through a connector. The docking station may further configure itself to accommodate the requirements of the portable device. Such configuring may include varying input impedance of the docking station's internal audio amplifier to match the portable device. In this way, the station can be used with a variety of portable devices, including devices from different manufacturers.

### FIELD OF THE INVENTION

The present invention relates generally to audio and video portable devices. More particularly, the invention relates to audio and video devices and docking stations for such devices.

### BACKGROUND

Portable devices, e.g., portable entertainment devices, have become ubiquitous in recent years. Such devices include audio players and, more recently, video players. Portable players may use MP3, RealAudio, MJPEG, MPEG, DV, and other audio and video compression formats. Moreover, as the cost, size, and power consumption of non-volatile memory devices decrease, use of uncompressed files in players may become more feasible. Players (both audio and video) may also use storage media such as compact discs (CDs) and digital video discs (DVDs).

Portable radio devices are also quite common. A portable radio may be a conventional radio with amplitude modulation (AM) and frequency modulation (FM) receiver bands, as have been know for many years. More recently, satellite radio devices, such as those offered by Sirius® Satellite Radio Inc. and XM® Satellite Radio Inc., have gained wide acceptance among consumers.

There is a variety of other portable electronic devices that can be used for entertainment, communications or other informational exchange, including, without limitation, television sets, dedicated game devices, game consoles, cellular telephones, portable digital assistants (PDAs), and voice recorders/players.

People often become familiar with the operation of their portable devices and develop preferences for a type of device or content format. People also do not want to incur the added expense of acquiring multiple accessory devices for supporting alternate formats or capabilities of portable entertainment, communication, and information devices. People may also store or receive their favorite entertainment or informational content on the portable devices, including by not limited to audio music, video clips, and personal contact information. Because of technical or digital copyright protection rights concerns, the content may or may not be transferable. Even transferable content may not be readily and easily transferable from one device to another and thus may limit a user's ability to consolidate content in a single device. Additionally, the organization of files may differ after the content is transferred to another device, creating problems of content playback, quality degradation, or complete loss of playback capability. Live streamed audio or video content may require a separate subscription or device activation for each device that receives the streamed signal, as is currently the case with some satellite radio broadcasts, causing additional expense to maintain the subscription and additional effort to activate each device with the service provider. For all these reasons, portable devices tend to be commonly used in different environments, even when portability is not a major concern—at home, in the office, or when traveling in a car, for example.

The transfer of content from one portable device to another or from one compression format to another has generated significant concern from copyright owners related to unauthorized reproduction of copyrighted materials, precipitating a demand of greater restrictions on the capability of portable devices to generate copies of audio and video content. Congress has helped to alleviate these concerns by passing the Audio Home Recording Act, which restricts digital radio device manufacturer from distributing devices capable of transferring digital content recorded from a digital satellite radio source. Thus, there is a need for devices for managing reproduction of recorded digital content.

While most electronics in general and memory storage devices in particular have shrunk and slimmed to a point where portability does not require substandard performance, a number of functional blocks still cannot be miniaturized without some sacrifice. Thus, design of a portable device naturally entails compromises because of size and weight limitations. A portable device may be battery-powered, have a small and power-efficient speakers and video display, use small (and therefore less efficient) antennae, and employ miniature user controls. These compromises naturally impose limitations on functionality, performance, and user interfaces of portable devices. Several companies have recognized these facts and are marketing “docking stations” for portable electronic devices to supplement the capabilities of the portable devices. A docking station allows its user to enjoy “non-portable” performance from a portable device. This is the case, for example, with the iPod® music players of Apple Computer Corporation, which can be plugged into a docking station.

Docking stations are typically designed for compatibility with a single product or with a line of products of a single manufacturer. Consequently, a user may be required to purchase and manufacturers may be required to develop, manufacture, and inventory multiple docking stations for use with portable devices of different manufacturers, or even for use with different product lines of the same manufacturer. This approach is inconvenient, expensive, and leads to inefficient use of space and manufacturers' resources.

### SUMMARY

A need thus exists for docking stations compatible with different entertainment, communication and informational devices, including portable devices made by different manufacturers.

Embodiments of the present invention are directed to methods, apparatus, and articles of manufacture that help satisfy this need. In some aspects, the invention herein disclosed is a docking station that includes a cradle interface capable of coupling the docking station to a cradle of a plurality of cradles, each cradle of the plurality of cradles capable of receiving at least one portable device at a time and electrically coupling the received portable device to the docking station through the cradle interface. The docking station also includes a device recognizer configured to recognize the type of portable device connected to the docking station through the cradle interface, and provide a signal corresponding to the determined type of device. The docking station varies its configuration in response to changes in the signal corresponding to the determined type of portable device. In this way, the docking station configures one or more of its components (e.g., power supply, audio amplifier input impedance, content storage and playback format) for operation compatible with the particular portable device plugged into the docking station through the cradle.

In selected aspects, the docking station includes a video display driven by a signal received from the portable device through a video input of the cradle interface.

In selected aspects, the device recognizer is configured to recognize a plurality of satellite radio portable devices.

In selected aspects, the device recognizer is configured to recognize a plurality of music player portable devices.

In selected aspects, the device recognizer is configured to recognize a plurality of game console portable devices.

In selected aspects, the device recognizer is configured to recognize a plurality of video player portable devices.

In selected aspects, the portable device recognizer is configured to recognize each portable device based on information stored in the cradle that couples the portable device to the docking station or based on information stored in the docking station itself.

In some aspects, the invention herein disclosed is a cradle capable of receiving at least one portable device at a time and electrically coupling the received portable device to the docking station.

In some aspects, the invention herein disclosed is a method of operating a docking station for portable devices. According to the method, various portable devices are received in the docking station through different cradles. The type of each received portable device is determined by the docking station, for example, by examining the signals received from the received portable device through the cradle that couples the received device to the docking station. The docking station is then configured responsive to the type of the portable device received by the station. The portable devices may be music players, video players, satellite radios, and other devices.

In some aspects, the invention herein disclosed is a docking station that includes a cradle interface capable of coupling the docking station to a first adaptive cradle and a second adaptive cradle. The first adaptive cradle is configured to receive a first portable device of a first type, and electrically couple the first portable device to the docking station. The second adaptive cradle is configured to receive a second portable device of a second type, and electrically couple the second portable device to the docking station. The docking station further includes means for enhancing functionality of the first portable device when the first portable device is coupled to the docking station via the first adaptive cradle, and for enhancing functionality of the second portable device when the second portable device is coupled to the docking station via the second adaptive cradle. In selected aspects, the means for enhancing functionality may include speaker(s), audio amplifier, video display, power supply, content storage and/or other components.

These and other features and aspects of the present invention will be better understood with reference to the following description, drawings, and appended claims.

### BRIEF DESCRIPTION OF THE FIGURES

FIG. 1 is a simplified diagram illustrating a portable device plugged into a versatile docking station via an adaptive cradle, in accordance with an embodiment of the present invention;

FIG. 2 is a simplified block diagram of the versatile docking station of FIG. 1, in accordance with an embodiment of the present invention;

FIG. 3 is a process flow diagram illustrating selected steps of a process of operating a versatile docking station, in accordance with an embodiment of the present invention;

FIG. 4 is a perspective view of a versatile docking station with an attached adaptive cradle, in accordance with an embodiment of the present invention;

FIG. 5 is a front view of the docking station and the adaptive cradle of FIG. 4 with a satellite radio plugged into the cradle, in accordance with an embodiment of the present invention;

FIG. 6 shows a combination of the docking station of FIG. 4 with a second cradle carrying a second portable device plugged into the docking station, in accordance with an embodiment of the present invention;

FIGS. 7, 8, and 9 illustrate front, side, and rear perspective views of another versatile docking station in combination with an adaptive cradle and a portable device, in accordance with an embodiment of the present invention;

FIG. 10 illustrates the versatile docking station of FIGS. 7-9 in combination with a different adaptive cradle and a different portable device, in accordance with an embodiment of the present invention;

FIG. 11 illustrates still another versatile docking station with a cradle, prior to plugging of the cradle into the docking station, in accordance with an embodiment of the present invention;

FIG. 12 shows front view of the versatile docking station of FIG. 11 with the adaptive cradle plugged into the docking station, in accordance with an embodiment of the present invention; and

FIGS. 13-16 illustrate top, rear, and side views of the combination of FIG. 12.

### DETAILED DESCRIPTION

In this document, including the appended claims, the words “embodiment” and “variant,” as well as similar expressions, refer to particular apparatus, process, or article of manufacture, and not necessarily to the same apparatus, process, or article of manufacture. Thus, “one embodiment” or a similar expression used in one place or context may refer to a particular apparatus, process, or article of manufacture; the same or a similar expression in a different place may refer to a different apparatus, process, or article of manufacture.

The expressions “alternative embodiment,” “alternatively,” and similar phrases are used to indicate one of a number of different possible embodiments. The number of potential embodiments is not necessarily limited to two or any other quantity.

The words “couple,” “connect,” and similar expressions with their inflectional morphemes do not necessarily import an immediate or direct connection, but include connections through mediate elements within their meaning.

The phrase “portable device” refers to electronic entertainment, communication, and informational devices designed for portability, i.e., for being carried by a person (by hand or on the person) in the course of the person's daily routines, such as working, walking, driving, exercising, and engaging in other activities.

A “docking station” is a device capable of accepting a portable device, and in particular a self-contained (i.e., fully functional) portable device, to enhance the functionality of the portable device, or provide additional functionality to the portable device. In particular, a docking station enhances performance of a portable device in areas where such performance is decreased due to portability of the portable device. A docking station may include, for example, speaker(s), video display, audio amplifier, power supply, audio or video content storage, improved user interface, interface capability with other devices and/or other enhancement components. A docking station may receive a portable device through a “cradle,” as is more fully described below.

“Type” of a portable device is a designation for one or more portable device classification(s) such that portable devices of the same type need to be treated in the same way by a docking station.

A “cradle” or an “adaptive cradle” means a device that provides electrical and mechanical interface for coupling a portable device, and particularly a portable device, to a docking station. Cradles are removable from and insertable into a docking station. Cradles may receive a single type of portable device or several types of portable devices. Different cradles may be compatible with a particular docking station. Cradles of a docking station serve as interfaces (mechanical and electrical) between the docking station and different types of portable devices. Cradles are more fully explained throughout the rest of this document.

A “music player” is a device for playing audio files stored on fixed or removable media.

A “video player” is a device for playing video files stored on fixed or removable media.

Other definitions may be found elsewhere in this document. The scope and spirit of the invention should not be construed as strictly limited to these definitions, or to the specific examples mentioned herein.

Reference will now be made in detail to one or more embodiments of the invention that are illustrated in the accompanying drawings. Same or similar reference numerals may be used in the drawings and the description to refer to the same apparatus elements and method steps. The drawings are in simplified form, not to scale, and omit apparatus elements and method steps that can be added to the described systems and methods, while including certain optional elements and steps. For purposes of convenience and clarity only, directional terms such as top, bottom, left, right, up, down, over, above, below, beneath, upper, lower, rear, and front may be used with respect to the accompanying drawings. These and similar directional terms should not be construed to limit the scope of the invention.

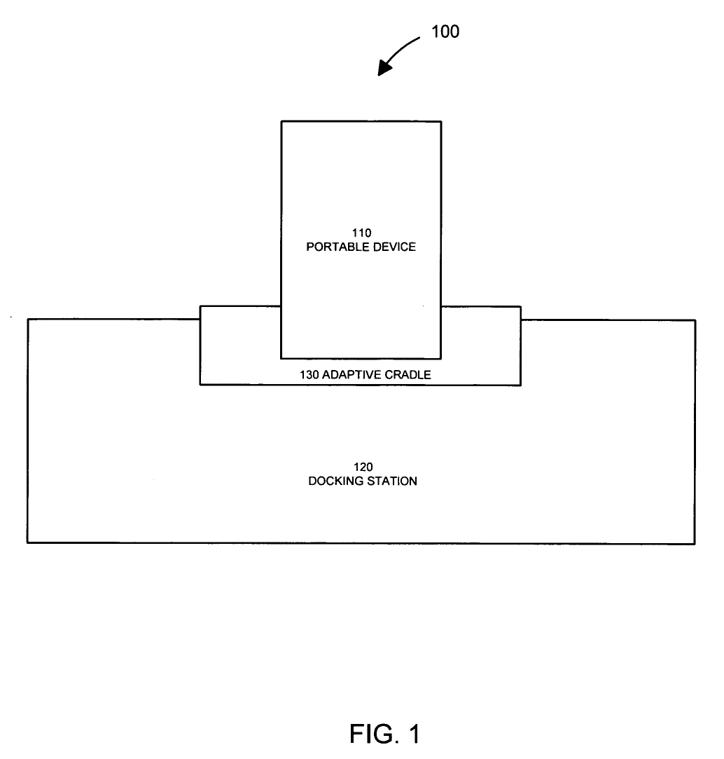

FIG. 1 shows a combination 100 that includes a portable device 110, a versatile docking station 120 for enhancing performance of portable devices such as music players and radios, and an adaptive cradle 130. As depicted in this Figure, the portable device 110 is plugged into the adaptive cradle 130, which is in turn plugged into the versatile docking station 120.

The portable device 110 may be capable of receiving, storing, and playing compressed or uncompressed audio and video files stored on the portable device or received via satellite broadcasts, cable or cellular network. The portable device 110 includes a docking interface for coupling to docking stations, for example, to native docking stations designed specifically for use with the particular portable device and, possibly, similar devices from a line of products with similar functions made or marketed by the same company. In variants of the combination 110, the portable device 110 is an iPod® player or a Sirius® satellite radio receiver.

In this embodiment, the adaptive cradle 130 performs three main functions. First, it receives and securely holds one or more portable devices for which it is designed, including the device 110. At the same time, the adaptive cradle 130 allows for a relatively easy mechanical and electrical engagement and disengagement of the portable devices, so that a user of the docking station 120 and the adaptive cradle 130 can plug in and remove the one or more portable devices without special skills or use of tools.

Second, the adaptive cradle 130 itself plugs in and securely attaches to the versatile docking station 120. The adaptive cradle 130 may be designed for easy mechanical and electrical engagement and disengagement with the versatile docking station 120, for example, without special skills or use of tools.

Third, the adaptive cradle 130 provides electrical connections that couple the docking interface of the portable device 110 to the versatile docking station 120. The electrical connections allow the docking station to enhance the operation of the portable device, e.g., by providing power, a better audio amplifier, better speakers, additional content storage capability, improved video output, etc.) In some variants, the electrical connections include (1) a connection for coupling an external antenna to the portable device, (2) external power supply input for the portable device, (3) a connection for the audio output of the portable device, and/or (4) a means to transfer audio or video content to the docking station memory. (“External” here means outside of the portable device 110.) In some variants, the electrical circuitry of the adaptive cradle 130 directly couples the docking interface of the portable device 110 to the corresponding connector of the versatile docking station. In other variants, the adaptive cradle 130 may include additional circuitry, for example, circuitry capable of recognizing the type of portable device plugged into it and transmitting a signal indicative of the type of the portable device to the versatile docking station 120. In another variant, the circuitry capable of recognizing the type or portable device and transmitting a signal indicative of the type of portable device can be located in the versatile docking station; however, to reduce cost in the docking station this circuitry may be built into the adaptive cradle. The adaptive cradle may also contain a module capable of providing digital rights management for content recorded onto the memory of the docking station.

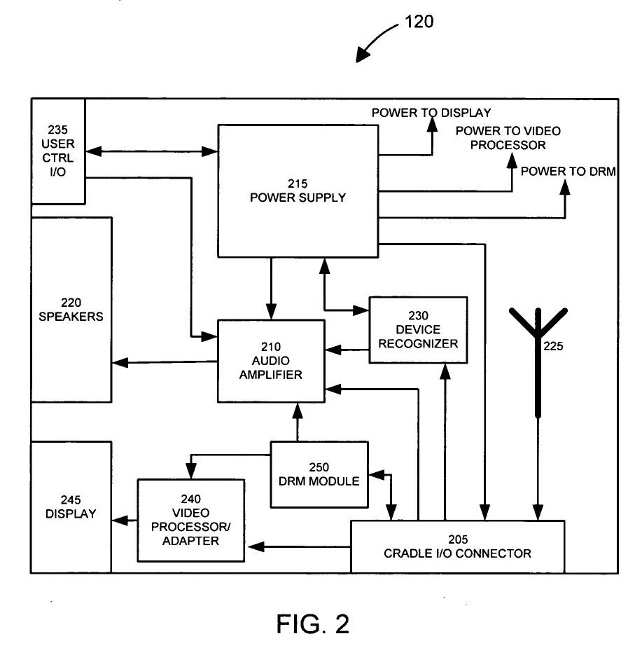

FIG. 2 is a simplified block diagram of the versatile docking station 120. The docking station 120 includes a cradle I/O connector 205, an audio amplifier 210, a power supply 215, speakers 220, an antenna 225, a device recognition module 230, a user control interface 235, a video processor/adapter 240, a display 245, and a digital rights management (DRM) module 250.

The cradle I/O connector 205 is designed to provide an electrical interface to various portable devices (e.g., the device 110) via multiple adaptive cradles, such as the adaptive cradle 130 shown in FIG. 1. The cradle I/O connector 205 connects appropriate line(s) from the adaptive cradle 130 to the audio amplifier 210, the power supply 215, the antenna 225, the device recognition module 230, the video processor/adapter 240, and the digital rights management module 250.

The audio amplifier 210 receives audio signals from the cradle I/O connector 205 and amplifies the audio signals to drive the speakers 220. The input of the audio amplifier 210 is designed to match impedance to the impedance of the audio output of the portable device 130. The input impedance of the amplifier 210 may be variable and configurable, so as to match different output impedances of different portable devices. The input impedance of the amplifier 210 may be controlled by the device recognition module 230, responsive to the specific type of the portable device plugged into the versatile docking station 120 via the adaptive cradle 130.

The output impedance of the audio amplifier 210 can match the impedance of the speakers 220, which the amplifier 210 drives.

Audio volume generated by the amplifier 210 is variable. It is controlled by the user control interface 235.

The video processor/adapter 240 receives video signals from the cradle I/O connector 205 and adapts the video signals for rendering on the display 245. The display 245 may be a liquid crystal display (LCD) device, black-and-white or color.

The digital rights management module 250 controls or restricts the use of the content played from the portable device 110 through the cradle I/O connector 205, thereby providing management of intellectual property rights to the content. Depending on availability of rights to the content, the digital rights management module 250 selectively enables and disables playback of the content, for example, by turning on and off the audio amplifier 210 and the video processor/adapter 240, or by enabling decryption of the audio and video signals received from the cradle I/O adapter 205.

The power supply 215 receives power from an external power source. In some embodiments, however, the versatile docking station 120 is battery powered, so that the power supply 215 receives its power from a portable power source, such as batteries. The power supply 215 converts the received power into power suitable for use in the other modules of the docking station 120, including the audio amplifier 210, the device recognition module 230, the user control interface 235, and other electrically-powered blocks within the station 120 (if present). Additionally, the power supply 215 is capable of providing electrical power for operation of the various portable devices that are compatible with the docking station 120. Note that the docking station 120 may be compatible with portable devices that require different power inputs. The specific power that the power supply 215 provides to the portable device is controlled by the requirements of the portable device, as indicated by the output of the device recognition module 9230.

The power provided to the portable device may be sufficient to operate the portable device, to charge secondary power cells in the portable device, or both to power the device and charge the device's internal rechargeable cells. Power and/or charging of the portable device may be controlled by the user of the versatile docking station 120 through the user control interface 235, or through controls provided on the portable device itself.

It should also be noted that the power supply 215 may be able simultaneously to provide multiple voltage levels to a single portable device.

The device recognition module 230 examines signals on the interface of the adaptive cradle 130 to determine the type of the portable device plugged into (or capable of being plugged into) the cradle 130. In some embodiments, each adaptive cradle 130 is capable of receiving portable devices of a single type. Such adaptive cradle may carry a memory, a set of switches (e.g., a DIP with configurable switches), or a similar circuit encoding the type of the portable device associated uniquely with the adaptive cradle 130. The device recognition module 230 reads the memory of the cradle and refers to an internal map correlating the information read to the type of the portable device. The device recognition module 230 then signals the power supply 215 and the audio amplifier 210, so that the power supply 215 and the amplifier 210 can be configured to match the requirements of the portable device 110.

In some embodiments, the versatile docking station 120 is built on a platform of one or more digital processing devices that perform, in part or in whole, various functions described above. The processing devices may include a general purpose processor controlled by program code, and other electronic components supporting operation of the processor, including memories, watchdog timers, interface devices, input/output (I/O) circuits, and other peripheral devices. The processor can be a microprocessor. Under control of the program code, the processor may (1) implement the device recognition module 230, e.g., read the memory of the adaptive cradle 130 and determine the type of portable device plugged (or pluggable) into the cradle 130; and (2) configure the audio amplifier 210 and the power supply 215 based on the determination of the type of the portable device 110. The processor, under control of the program code, may further read the user inputs to the user control interface 235 and respond appropriately to these inputs. For example, the processor may vary the audio volume generated by the audio amplifier 210 responsive to a volume control setting on the user control interface 235. By way of another example, the processor may receive from the user codes associated with digital rights to content, determine whether rights to a particular item of content are available, and enable or disable playback of the particular item of content depending on availability of the rights.

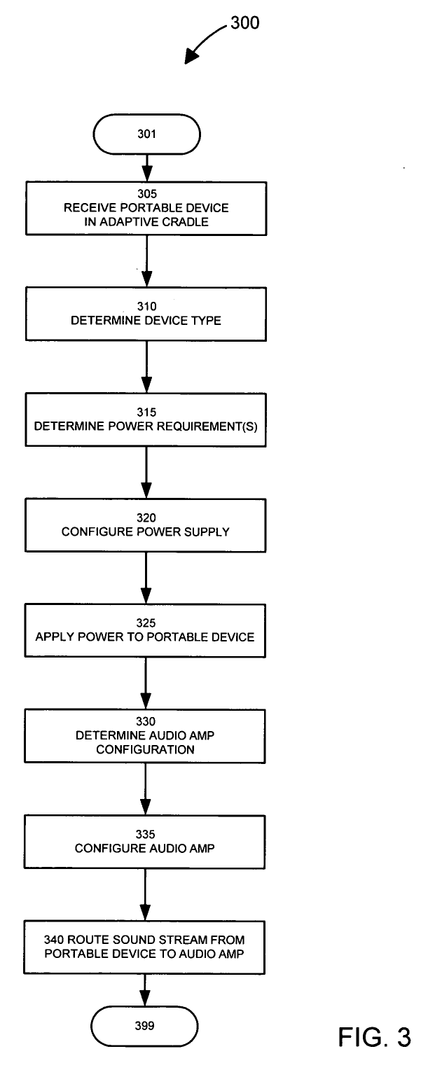

FIG. 3 is a process flow diagram illustrating selected steps of a process 300 of operating a versatile docking station. Although certain process steps are described serially, some of these steps can be performed by separate elements in conjunction or in parallel, asynchronously or synchronously, in a pipelined manner, or otherwise. There is no particular requirement that the steps be performed in the same order in which this description lists them, except where explicitly so indicated, otherwise made clear from the context, or inherently required. Furthermore, not every illustrated step is required in every embodiment in accordance with the invention, while some steps that have not been specifically illustrated may be desirable or necessary in some embodiments in accordance with the invention.

At flow point 301, the versatile docking station is ready for connecting to a portable device.

At step 305, the versatile docking station receives the portable device. For example, an adaptive cradle carrying the portable device is plugged into the versatile docking station. As another example, the portable device is plugged into the cradle that was previously inserted into the versatile docking station. By way of still another example, the portable device that has been previously plugged into the versatile docking station via an adaptive cradle, is turned on via an ON/OFF switch of the portable device itself.

At step 310, the versatile docking station determines the type of the portable device plugged into the station. For example, the versatile docking station reads a memory or DIP switch seting in the portable device through the adaptive cradle to determine the type of the plugged-in device in general (or even the specific plugged-in device based on the device's serial number). Alternatively, the versatile docking station can infer the type of the portable device based on the type of the adaptive cradle through which the device is plugged into the docking station. This may also be achieved by reading some memory or switch setting in the cradle.

At step 315, the versatile docking station determines the power requirements of the portable device. For example, the docking station can maintain a map that correlates the types of the portable devices that can be plugged into the station versus the power requirements of such devices. The processor of the versatile docking station can then refer to this map to read the power requirements of the portable device. If the docking station is connected to external devices (e.g., a computer or a network, such as the Internet), it can access an external source of information to determine the power requirements of the portable device based on the data about the portable device (which the station obtained from its device recognition module).

At step 320, the versatile docking station configures its internal power supply module (such as the power supply 215 of FIG. 2) to provide the power needs of the portable device in accordance with the determination of the type of the portable device.

At step 325, the versatile docking station applies to the portable device the power appropriate to the portable device, as configured in the preceding step. In some process embodiments, the steps 320 and 325 are combined. For example, the docking station sends a signal configuring its power supply so as to connect a particular DC voltage to a particular input of the interface (e.g., the connector 205) to the adaptive cradle. Application of the power to the portable device may also be conditioned by a power switch of the docking station, for example, a power switch of the user control interface 235.

At step 330, the versatile docking station determines the appropriate configuration for its internal audio amplifier (e.g., the audio amplifier 210 in FIG. 2). For example, the docking station can determine the required input impedance of the audio amplifier. As in the case of determining the power supply requirements of the portable device (step 315), the docking station can maintain a map that interrelates the types of the portable devices that can be plugged into the station and the required audio amplifier configuration of the station. For example, the map can interrelate the required input impedance of the audio amplifier with the device types. The processor of the versatile docking station can then refer to this map to read the audio amplifier configuration needed to accommodate the portable device. Once again, a networked docking station may also access external source(s) to determine the desirable configuration of the amplifier from the data identifying the type of portable device plugged into the docking station.

At step 335, the versatile docking station configures the audio amplifier in accordance with the amplifier configuration determined in the previous step.

At step 340, the station routes the sound output of the portable device to the audio amplifier.

It should be noted that the steps 335 and 340 can be performed substantially at the same time. Furthermore, the steps 315 (determining device power requirements) and 330 (determining amplifier configuration) can also be performed substantially at the same time. For example, the versatile docking station can map the type of portable device to the device's power and audio amplifier requirements substantially simultaneously, then configure the power supply module and the audio amplifier also substantially simultaneously, and finally connect the power and the audio amplifier at the same (or practically the same) time.

After the step 340, the process 300 terminates at flow point 399.

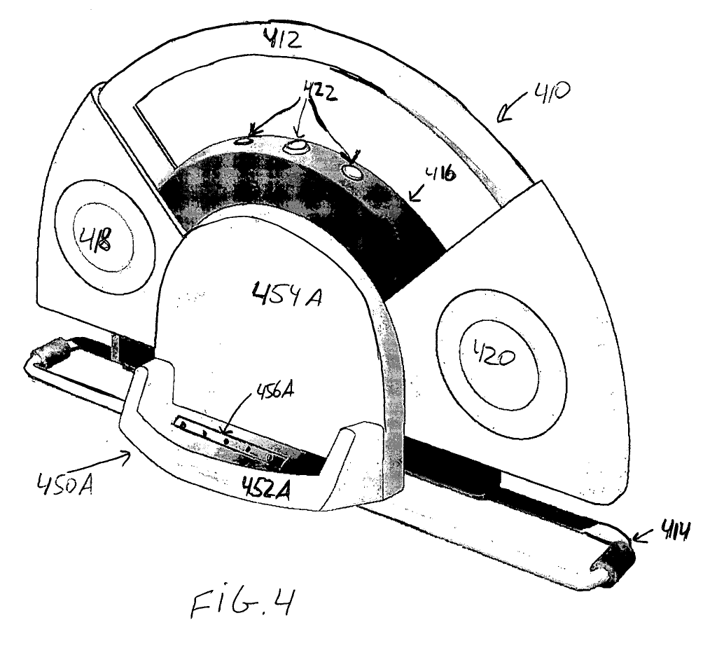

FIG. 4 is a perspective view of a versatile docking station 410 with an attached adaptive cradle 450A. In this embodiment, the docking station 410 includes a carrying handle 412, a stand 414, a main body 416, a pair of speakers 418 and 420, and user control interface buttons/dials 422 that are disposed on top of the main body 416. The main body 416 houses various components, such as an audio amplifier and a power supply module.

The adaptive cradle 450A that is shown plugged into the versatile docking station 410 in FIG. 4 is designed for receiving a Sirius® Sportster satellite radio. The cradle 450A includes a base portion 452A and a backing portion 454A. An interface connector 456A for coupling a satellite radio is disposed in the base portion 452A.

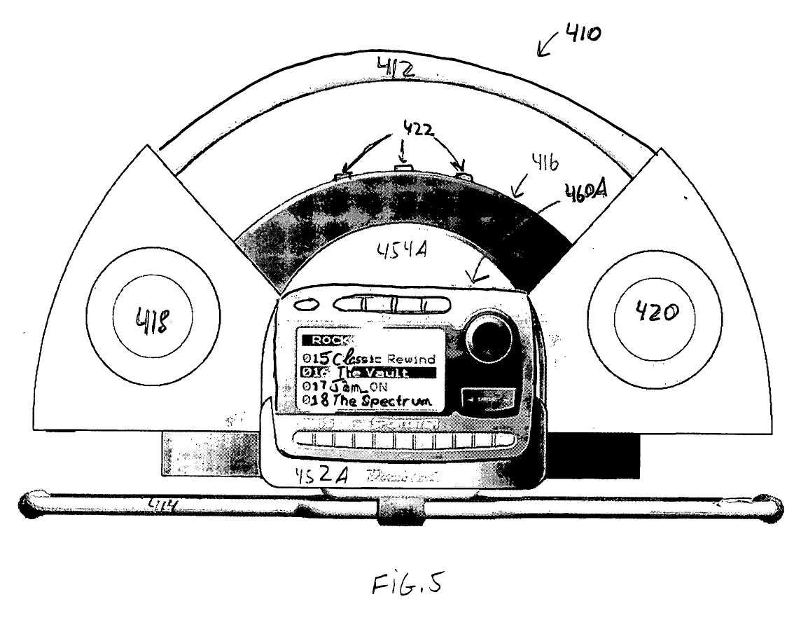

FIG. 5 shows a front view of the combination of the docking station 410 and the adaptive cradle 450A with a satellite radio 460A plugged into the cradle 450A.

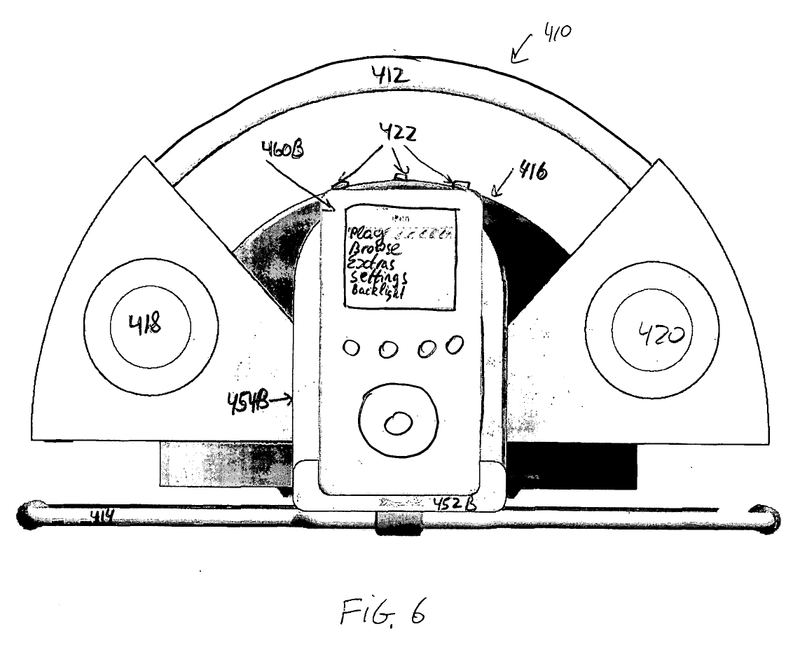

The versatile docking station 410 can receive other adaptive cradles in addition to the cradle 450A. To illustrate this concept, FIG. 6 shows a combination of the docking station 410 with a cradle 450B plugged into it. As in the case of the adaptive cradle 450A, the adaptive cradle 450B also includes a base portion 452B and a backing portion 454B. This cradle, however, is designed to receive a music player (ipod®) device 460B, as shown in FIG. 6.

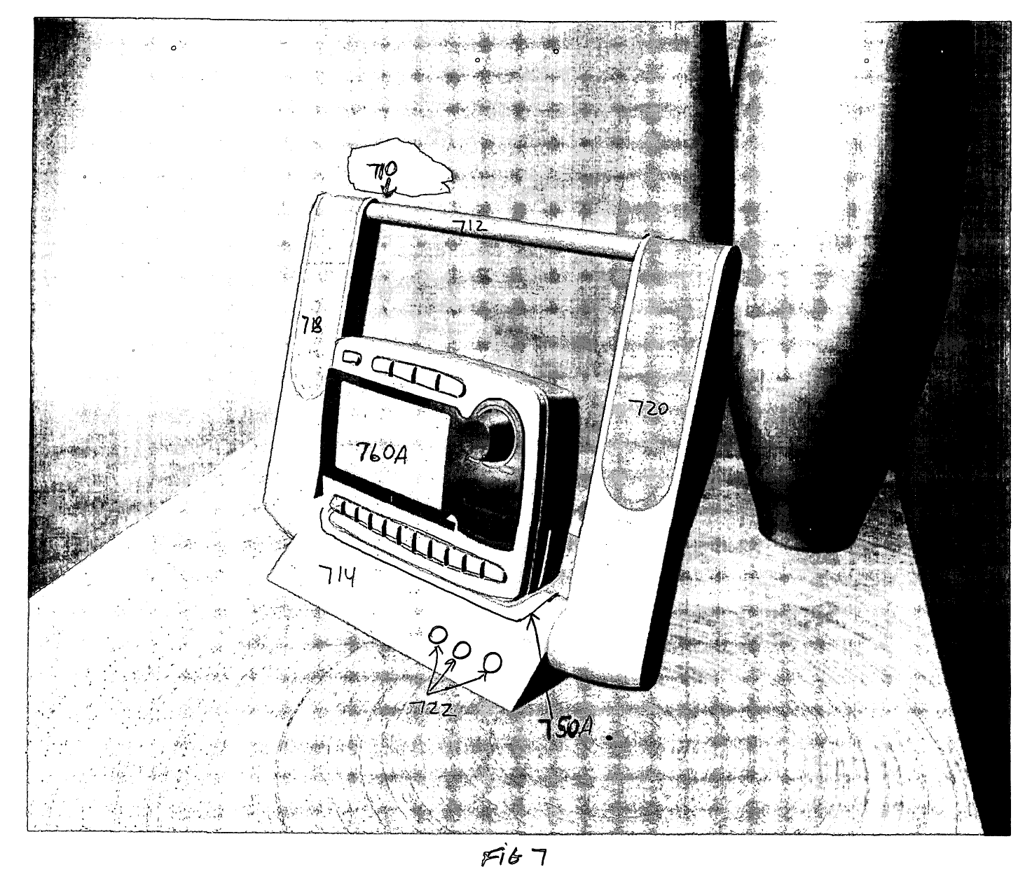

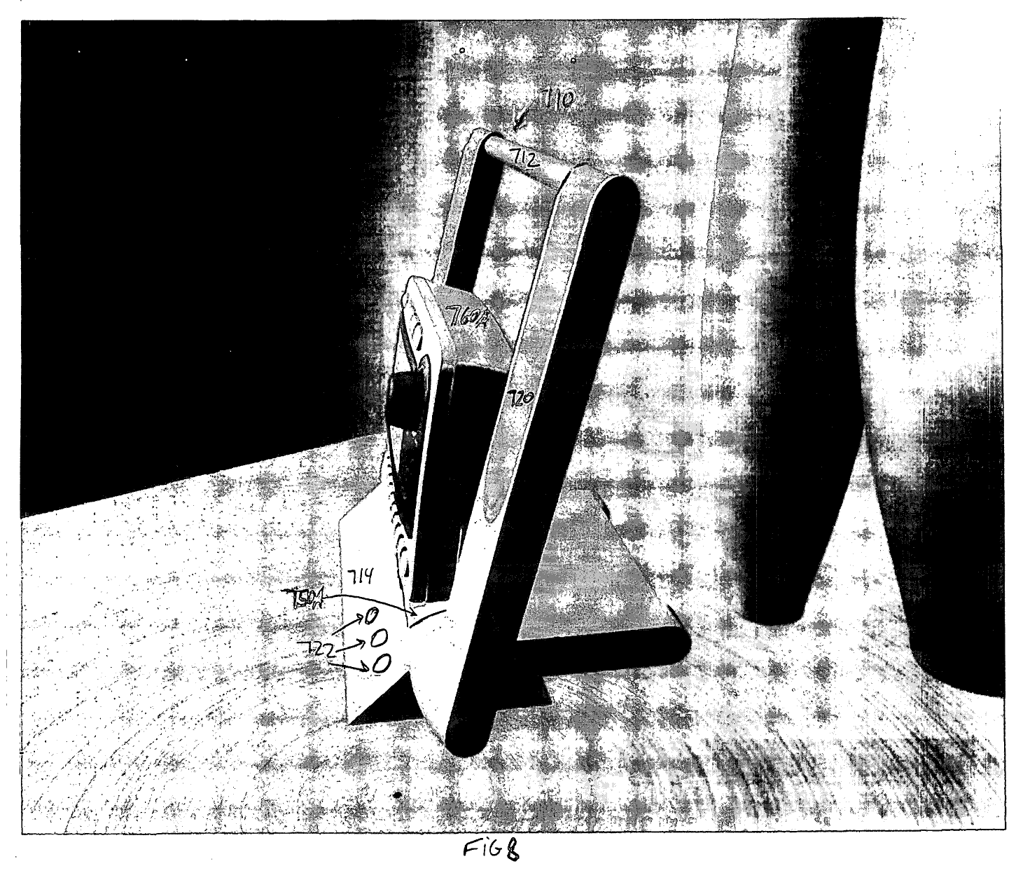

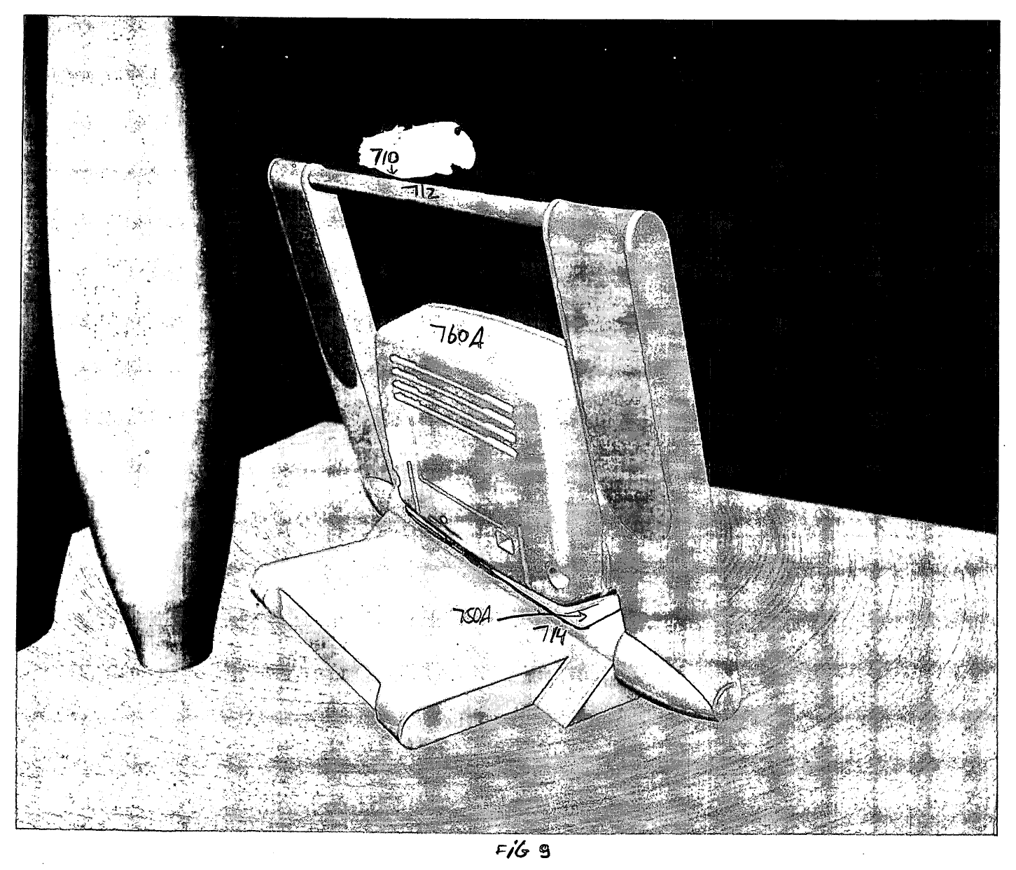

FIGS. 7, 8, and 9 illustrate front, side, and rear perspective views of a versatile docking station 710 in combination with an adaptive cradle 750A and a portable device 760A. The docking station 710 includes a carrying handle 712, main body/stand 714, and speakers 718 and 720. The main body/stand 714 includes a recess with a connector for receiving the cradle 750A. (The recess and the connector are obscured by the adaptive cradle 750A and the portable device 760A.) The main body/stand 714 also houses buttons/dials 722 of the user control interface.

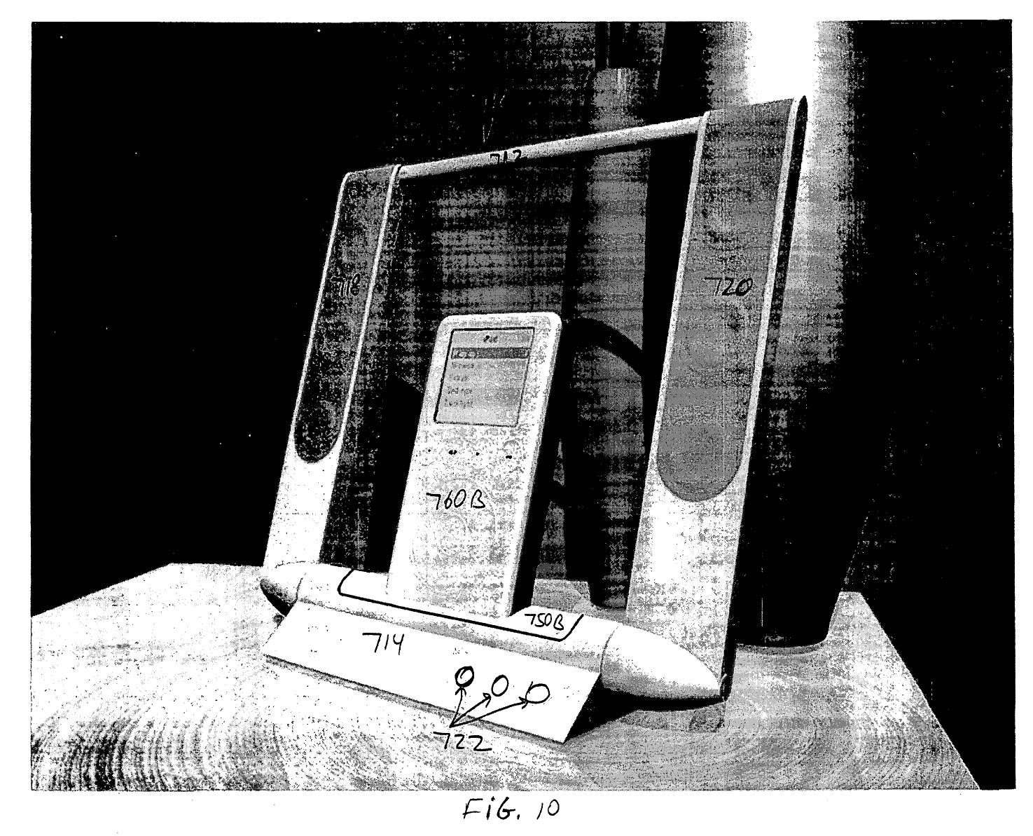

FIG. 10 illustrates the docking station 710 in combination with another cradle, 750B. The cradle 750B is designed to receive a different portable device, 760B, as is shown in this Figure.

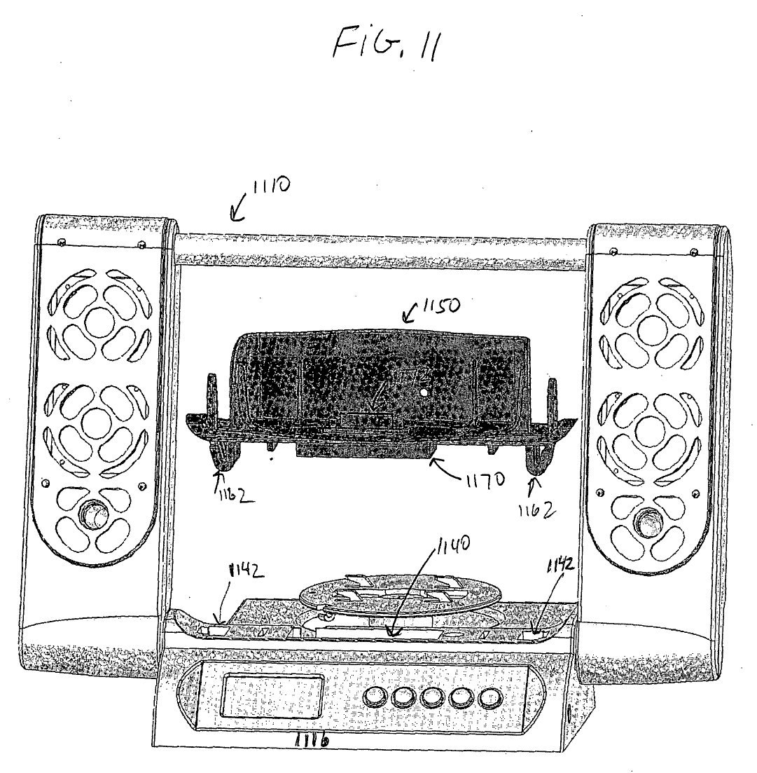

FIG. 11 illustrates yet another concept of a versatile docking station. As in the embodiments discussed above, a docking station 1110 is capable of receiving a plurality of different cradles, such as the cradle 1150, which is shown prior to its insertion into the station 1110. Note that the cradle 1150 includes a pair of spring-loaded prongs 1162 of a latching mechanism. The docking station 1110 is designed to receive the prongs 1162 into matching openings 1142, and thus latch onto the cradle 1150. Electrical contact between the cradle 1150 and the docking station 1110 is maintained via a connector 1170 (of the cradle 1150) and a matching connector in a recess 1140 within a main body 1116 of the docking station 1110. Electrical contact between the adaptive cradle 1150 and a portable device (not shown) pluggable into the cradle 1150 is maintained through a connector 1172.

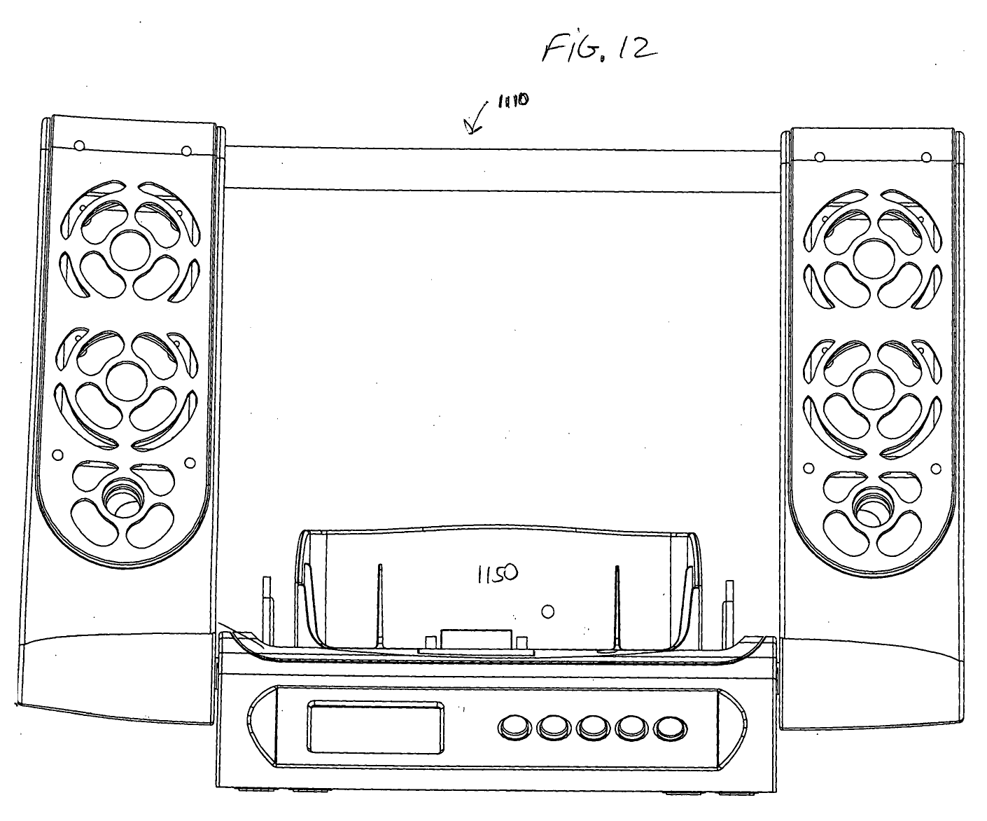

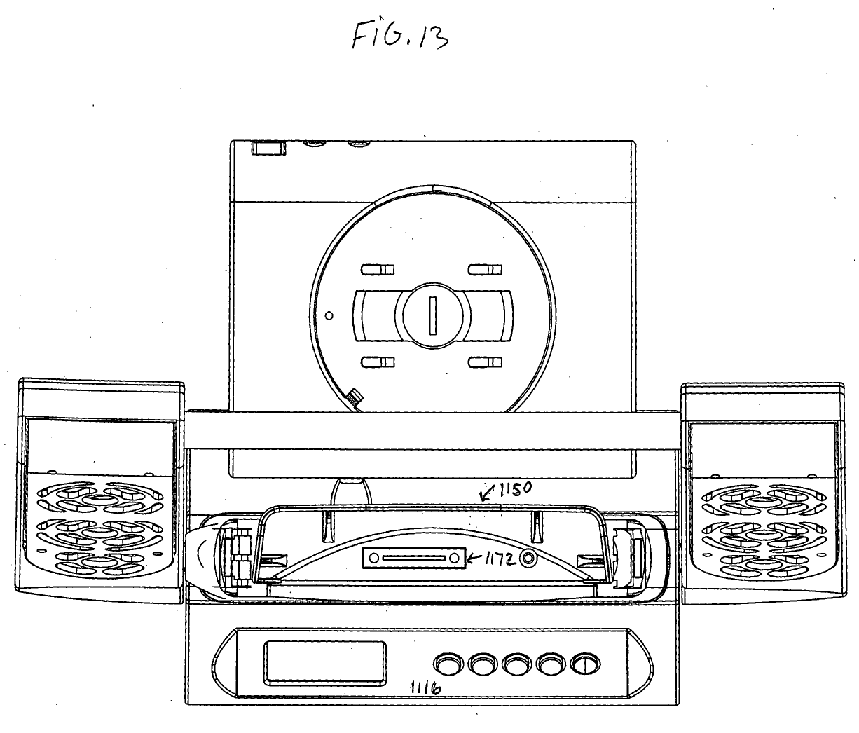

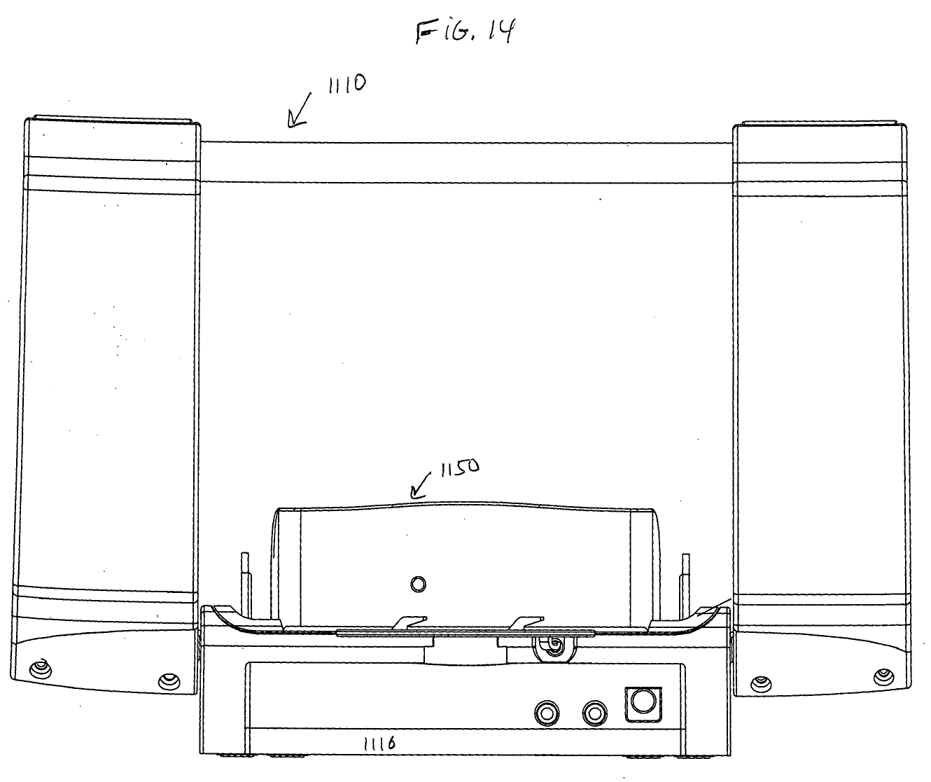

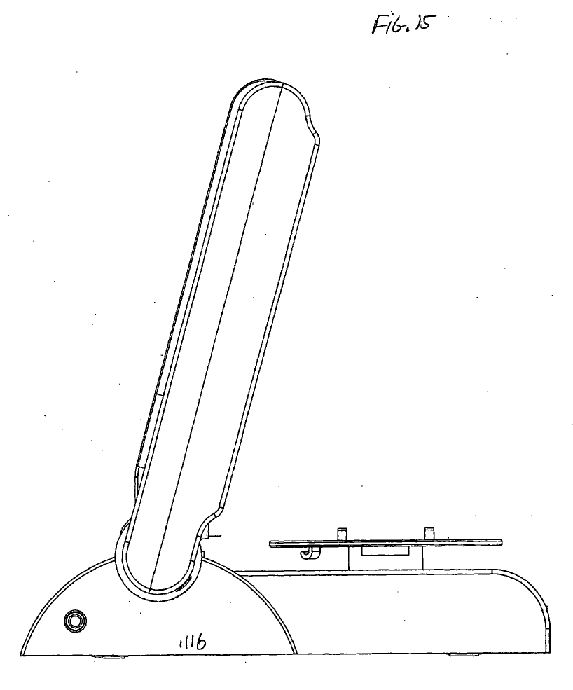

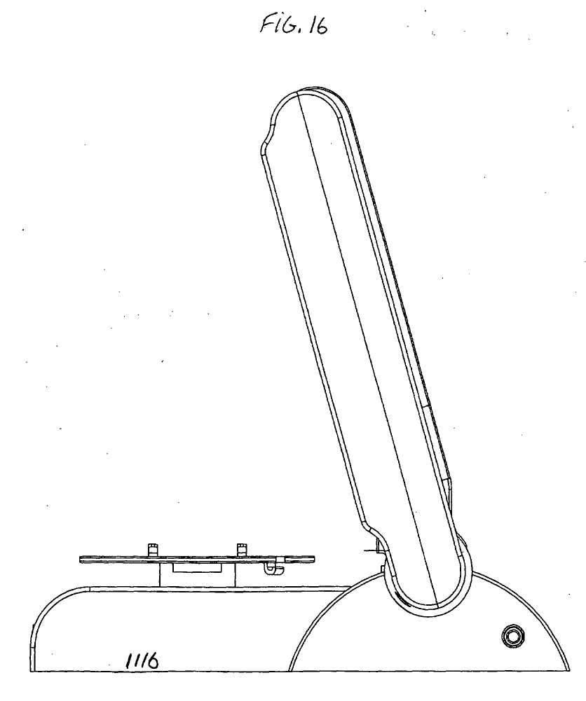

FIG. 12 shows front view of the versatile docking station 1110 with the adaptive cradle 1150 plugged into it. FIGS. 13-16 illustrate, respectively, top, rear, and two side views of the combination of FIG. 12.

A versatile docking station in accordance with the present invention may be adapted to receive portable devices capable of providing video output streams. Such docking station may include a screen for video display in addition to (or instead of) speakers. The docking station may further couple to or be part of a television set, audio equipment, dedicated game machine, multi-game console, or home theater equipment.

This document describes in considerable detail the inventive versatile docking stations, adaptive cradles, and methods of their operation. This was done for illustration purposes only. Neither the specific embodiments of the invention as a whole, nor those of its features limit the general principles underlying the invention. The specific features described herein may be used in some embodiments, but not in others, without departure from the spirit and scope of the invention as set forth. Various physical arrangements of components and various step sequences also fall within the intended scope of the invention. Furthermore, the invention need not necessarily be limited to portable applications, but may extend to applications involving larger devices. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is carried out by the claims and their equivalents.

We claim

1. A docking station comprising:
a cradle interface capable of coupling the docking station to a cradle of a plurality of cradles, each cradle of the plurality of cradles capable of receiving at least one portable device at a time and electrically coupling the received portable device to the docking station through the cradle interface; and
a device recognizer configured to recognize type of portable device connected to the docking station through the cradle interface, and provide a signal corresponding to the determined type of portable device;
wherein the docking station varies configuration of the docking station in response to changes in the signal corresponding to the determined type of portable device.

2. A docking station according to claim 1, further comprising a configurable power supply module capable of providing power to portable devices through the cradle interface, wherein the power supply module is configured responsive to the determined type of portable device.

3. A docking station according to claim 1, further comprising an audio amplifier configured to receive an audio signal from portable devices through the cradle interface, wherein the audio amplifier is configured responsive to the determined type of portable device.

4. A docking station according to claim 3, further comprising a digital rights management module configured selectively to enable playback of the audio signal depending on availability at the docking station of rights to content represented by the audio signal.

5. A docking station according to claim 1, further comprising an audio amplifier configured to receive an audio signal from portable devices through the cradle interface, wherein input impedance of the audio amplifier is configured responsive to the determined type of portable device.

6. A docking station according to claim 5, further comprising a configurable power supply module capable of providing power to portable devices through the cradle interface, wherein the power supply module is configured responsive to the determined type of portable device.

7. A docking station according to claim 1, further comprising a video display, wherein the cradle interface comprises video input for driving the video display with one or more video signals.

8. A docking station according to claim 7, further comprising a digital rights management module configured selectively to enable playback of the one or more video signals depending on availability at the docking station of rights to content represented by the audio signal.

9. A docking station according to claim 1, wherein the device recognizer is configured to recognize a plurality of satellite radio portable devices.

10. A docking station according to claim 1, wherein the device recognizer is configured to recognize a plurality of music player portable devices.

11. A docking station according to claim 1, wherein the device recognizer is configured to recognize a plurality of game console portable devices.

12. A docking station according to claim 1, wherein the device recognizer is configured to recognize a plurality of video player portable devices.

13. A docking station according to claim 1, wherein the device recognizer is configured to recognize each portable device based on information stored in the cradle that couples said each portable device to the docking station.

14. A cradle capable of receiving at least one portable device at a time and electrically coupling the received portable device to the docking station of claim 1.

15. A method of operating a docking station for portable devices, the method comprising:
receiving a first portable device in the docking station through a first adaptive cradle;
determining type of the first portable device; and
configuring the docking station responsive to the type of the first portable device.

16. A method of operating a docking station according to claim 15, wherein the step of receiving a first portable device comprises:
receiving the first portable device in the first adaptive cradle designed to interface the docking station to at least portable devices of the same type as the first portable device; and
receiving the first adaptive cradle in the docking station.

17. A method of operating a docking station according to claim 16, further comprising:
receiving a second portable device in the docking station through a second adaptive cradle;
determining type of the second portable device; and
configuring the docking station responsive to the type of the second portable device;
wherein the step of receiving a second portable device comprises:
receiving the second portable device in the second adaptive cradle designed to interface the docking station at least to portable devices of the same type as the second portable device, and
receiving the second adaptive cradle in the docking station.

18. A method of operating a docking station according to claim 17, wherein the first portable device and the second portable device are music player devices.

19. A method of operating a docking station according to claim 17, wherein the first portable device and the second portable device are satellite radio devices.

20. A method of operating a docking station according to claim 17, wherein the first portable device is a music player device, and the second portable device is a satellite radio device.

21. A method of operating a docking station according to claim 16, further comprising:
providing power for operating the first portable device from the docking station;
wherein configuring the docking station comprises configuring the power provided to the first portable device responsive to the type of the first portable device.

22. A method of operating a docking station according to claim 16, further comprising:
using an audio amplifier to amplify an audio signal received at the docking station from the first portable device through the first adaptive cradle;
wherein configuring the docking station comprises configuring the audio amplifier responsive to the type of the portable device.

23. A method of operating a docking station according to claim 22, wherein configuring the audio amplifier comprises configuring input impedance of the audio amplifier responsive to the type of the first portable device.

24. A method of operating a docking station according to claim 22, further comprising:
providing power for operating the first portable device from the docking station;
wherein configuring the docking station comprises configuring the power provided to the first portable device responsive to the type of the first portable device.

25. A docking station comprising:
a cradle interface capable of coupling the docking station to a first adaptive cradle and a second adaptive cradle, wherein the first adaptive cradle is configured to receive a first portable device of a first type, and electrically couple the first portable device to the docking station, and wherein the second adaptive cradle is configured to receive a second portable device of a second type, and electrically couple the second portable device to the docking station; and
means for enhancing functionality of the first portable device when the first portable device is coupled to the docking station via the first adaptive cradle, and for enhancing functionality of the second portable device when the second portable device is coupled to the docking station via the second adaptive cradle.
